(19) United States
(12) Patent Application Publication
(10) Pub. No.: US 2011/0053514 A1
(43) Pub. Date: Mar. 3, 2011

(54) REJECTION OF A CLOSE-IN-FREQUENCY INTERFERER EMPLOYING A LOG DETECTOR AND CLASSICAL DOWN CONVERTER

(76) Inventors: Joel B. Simoneau, Harvest, AL (US); J. Wilson Pearson, Seneca, SC (US)

(21) Appl. No.: 12/811,877

(22) PCT Filed: Jan. 9, 2009
(86) PCT No.: PCT/US09/30522

§ 371 Date: Oct. 20, 2010

Related U.S. Application Data
(60) Provisional application No. 61/020,580, filed on Jan. 11, 2008.

(51) Int. Cl. H04B 15/00

(52) U.S. Cl. 455/63.1

(57) ABSTRACT

Disclosed is a methodology and apparatus for rejecting a high-power, near-in-frequency, radio frequency interference. The subject rejection methodology provides two branches; one is a classical down converter branch, and the other is a log detector followed by a high pass filter. The two branches produce a complex multiplication which cancels the highest inter modulation product and the final output is presented at the originally intended intermediate frequency. The methodology is appropriate for a constant-amplitude modulation on the interferer and any combination of phase, frequency, and amplitude modulation on the intended signal.

### FIELD OF THE INVENTION

The present subject matter relates to apparatus and methodologies for rejecting radio interference. More particularly, the present subject matter introduces apparatus and methodologies for rejecting interference from an interfering signal source that is close in frequency to a frequency of interest that avoids the use of an RF filter.

### BACKGROUND OF THE INVENTION

In the processing of radio frequency (RF) signals, it is a frequent occurrence that a strong interference signal (an interferer) must be rejected in order to process a desired radio frequency signal. Classically, this is achieved by the use of a high-Q RF filter that rejects signals in frequency ranges except the desired one. Generally the frequency difference between the desired and interfering signal dictates the order and therefore expense of the RF filter that must normally be employed. Further, the requirement for high-Q in separating closely spaced signals generally precludes the filter's being realized in an economical technology.

Frequency-agile radio systems now being developed will operate with the frequency of the desired signal varying over a substantial range. To process a desired RF signal in the presence of interference with an RF filter, requires that the filter be high-Q and frequency-agile, thereby adding further to cost.

While various implementations of interference rejection and suppression apparatus and methodologies have been developed, no design has emerged that generally encompasses all of the desired characteristics as hereafter presented in accordance with the present subject matter.

### SUMMARY OF THE INVENTION

In view of the recognized features encountered in the prior art and addressed by the present subject matter, apparatus and methodology for providing improved rejection of interfering radio frequency sources without the use of a radio frequency (RF) filter has been provided.

In one of its forms, selective IF processing is provided based, in part, on frequency distance of an interferer from a desired signal.

Another positive aspect of this type of device is that the present technology may be implemented in whole or in part in software or hardware.

In accordance with certain aspects of other embodiments of the present subject matter, conventional RF filtering requirements can be eliminated or significantly reduced.

In accordance with yet additional aspects of the present subject matter, the rejection technology is appropriate for a modulated sinusoidal interferer and any combination of phase, frequency, and amplitude modulation on the intended signal.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents including combinations of features, parts, or steps or configurations thereof not expressly shown in the figures or stated in the detailed description of such figures. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a block diagram of an exemplary interference reducing system architecture in accordance with the present subject matter;

FIG. 2a is a plot of output SIR (dB) vs. Frequency Separation QPSK interferer modulation illustrating a theoretical level of output SIR of 20 dB;

FIG. 2b is a plot of output SIR (dB) vs. Frequency Separation, BFSK interferer modulation illustrating a theoretical level of output SIR of 20 dB;

FIG. 3a is a plot of output SIR vs. input SIR, QPSK modulated interferer assuming −45 dB of leakage in the multipliers and illustrating a frequency separation of 200 kHz;

FIG. 3b is a plot of Output SIR vs. input SIR, BFSK modulated interferer assuming −45 dB of leakage in the multipliers, a frequency separation of 400 kHz and a modulation rate of 100 kHz;

FIG. 4 is plot of Intermodulation Rejection (dB) vs. Ratio of Symbol Rate to Frequency Separation; and

FIG. 5 is a plot of output power in Branch 2 illustrated in FIG. 1 vs. frequency with a difference frequency of 150 kHz.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with apparatus and methodology for providing improved rejection of interfering radio frequency sources without the use of a radio frequency (RF) filter.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The present subject matter introduces a method of rejecting a source of interference (an interferer) that is close in frequency to a desired signal frequency without the use of an RF filter. The present subject matter is particularly relevant, although not exclusively so, where it is desired to lessen the frequency requirements of high-Q RF filters that may be employed in frequency-agile dynamic radio systems. Thus while it is intended that the use of RF filtering may be eliminated through the use of the present technology, the use of such filtering at reduced capability levels in combination with the present technology is also anticipated.

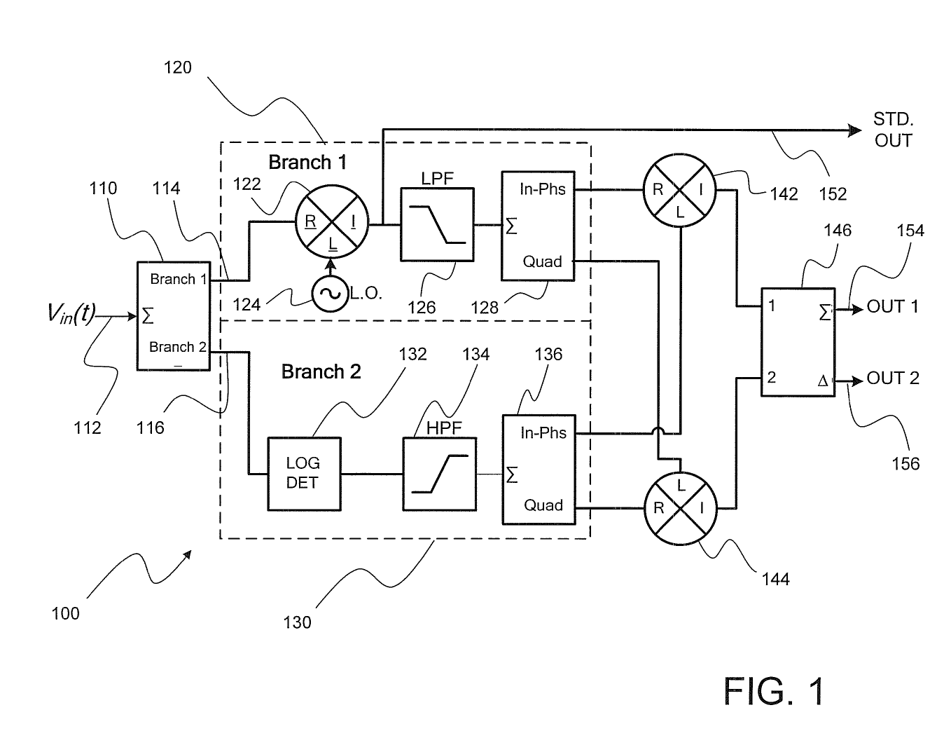

Reference will now be made in detail to the presently preferred embodiments of the subject interference rejection system and methodology. Referring now to the drawings, FIG. 1 illustrates a block diagram of exemplary system architecture 100 in accordance with the present subject matter. As may be seen in FIG. 1, an input signal Vᵢₙ(t) may be applied to input terminal 112 of divider 110 and supplied, after division, to output terminal pairs 114, 116 for application to Branch 1 and Branch 2, respectively, of signal processing branches 120, 130.

A signal from terminal 114 of divider 110 is applied to one input of a multiplier 122 within branch 120. A second input terminal of multiplier 122 receives an input signal from a local oscillator 124. The multiplier output signal is supplied as a standard output to line 152 and to an input of low pass filter 126 whose output is coupled to a the input of 90 degree hybrid divider 128. Divider 128 produces in-phase and quadrature signals that are applied to one input each of multipliers 142 and 144.

A second signal from divider 110 is applied via divider terminal 116 to one input of a logarithmic detector 132 whose output signal is applied to an input terminal of high pass filter 134. The output of high pass filter 134 is applied to an input terminal of 90 degree hybrid divider 136. Logarithmic detector 132, high pass filter 134, and divider 136 correspond to a second branch of the exemplary system architecture 100. As may be seen in FIG. 1, 90 degree hybrid divider 136 is similar to 90 degree hybrid divider 128 in Branch 1 and also provides in-phase and quadrature signals to one input each of the previously mentioned multipliers 142, 144.

As may be further observed from an inspection of FIG. 1, the outputs from both multipliers 142 and 144 are applied to separate input terminals of hybrid device 146. Hybrid device 146 has a pair of output terminals and produces at output terminal 154 a sum signal, i.e., a signal representing the sum of the input signals, and at second output terminal 156 a difference signal representing the difference between the two input signals.

The methodology of the present technology is suitable for rejecting a near-in-frequency, constant amplitude interferer that is up to 30 dB higher than the desired signal. If the interfering signal is either frequency or phase modulated, this system is suitable when the interference is higher than the desired signal in the desired frequency band, as long as the center frequency of the interferer and desired signal are separated sufficiently. Frequency, phase, and amplitude modulation may be applied to the desired signal with identical theoretical results.

It will be appreciated by those of ordinary skill in the art upon study of the present disclosure that this system relies on the high-power interfering signal to properly sense the desired signal. If the interferer's operation is intermittent, then the receiver should monitor the signal to interference ratio at each of the outputs and switch between this system and the classical down converter illustrated in Branch 1 of FIG. 1 alone when the signal to interference ratio is on the order of one or above.

The basic operation of a system constructed in accordance with present technology may be described as follows. Suppose the system in FIG. 1 is excited by a two-tone input of the form:

vᵢₙ(t)=V₀ cos(ω₀t+φ₀)+V₁ cos(ω₁t+φ₁) (4.1)

where V₁, φ₁, and ω₁ are associated with a desired signal, and V₀, φ₀, and ω₀ are associated with a stronger interference signal, i.e., V₀>>V₁. Branches 1 and 2 of the system respectively process this input using both traditional heterodyne down conversion and log detection per present disclosure. The signals:

$$\begin{matrix}{v}_{B 1} ( t ) = {G}_{mix} {G}_{LNA} [ {V}_{0} cos ( {ω}_{IF 0} t + {φ}_{0} ) + {V}_{1} cos ( {ω}_{IF 1} t + {φ}_{1} ) ] \\ and & ( 4.2 ) \\ {v}_{B 2} ( t ) = {G}_{HP} {C}_{det} \frac{{V}_{1}}{{V}_{0}} cos ( Δ ω t + Δφ + {θ}_{HP} ) & ( 4.3 )\end{matrix}$$

with Δω=ω₀−ω₁, and Δφ=φ₀−φ₁ result. The local oscillator 124 frequency is co_{w} and the intermediate frequencies are ω_{Ifi}=ωᵢ−ω_{LO}, i=1,2. Gₘᵢₓ and G_{LNA} are the gain of the mixer 122 and low pass filter 126, respectively, and C_{det} and G_{HP} are the voltage gain of the log detector 132 and high pass filter 134, respectively. The result shown in Equation 4.3 follows from the analysis in Simoneau et al.'s article, “Multitone Feedback through Demodulating Log Detector for Detection of Spurious Emissions in Software Radio,” accepted, IEEE Trans. Circ. and Sys., where a high-pass filter is employed to filter out the baseband term. In Equation 4.3, G_{HP} and θ_{HP} are the magnitude and phase response, respectively, of the high-pass filter at the difference frequency.

The in-phase and quadrature product of the outputs of Branches 1 and 2 are, respectively.

$$\begin{matrix}{v}_{mult 1} ( t ) = {G}_{HP} {C}_{det} {G}_{mix} {G}_{LNA} [ \begin{matrix}\begin{matrix}\frac{{V}_{1}}{2} cos ( {ω}_{IF 1} t + {φ}_{1} + {θ}_{HP} ) + \\ \frac{{V}_{1}}{2} cos ( ( Δω + {ω}_{IF 0} ) t + {φ}_{0} + Δφ + {θ}_{HP} ) +\end{matrix} \\ \frac{{V}_{1}^{2}}{{V}_{0}} ( cos ( Δω t + Δφ + {θ}_{HP} ) cos ( {ω}_{IF 1} t + {φ}_{1} ) )\end{matrix} ] \\ and & ( 4.4 ) \\ {v}_{mult 2} ( t ) = {G}_{HP} {C}_{det} {G}_{mix} {G}_{LNA} [ \begin{matrix}\begin{matrix}\frac{{V}_{1}}{2} sgn ( Δ ω ) cos ( {ω}_{IF 1} t + {φ}_{1} + {θ}_{HP} ) - \\ \frac{{V}_{1}}{2} sgn ( Δω ) cos ( \begin{matrix}( {ω}_{IF 1} + 2 Δω ) t + \\ {φ}_{0} + Δ φ + {θ}_{HP}\end{matrix} ) +\end{matrix} \\ \frac{{V}_{1}^{2}}{{V}_{0}} ( sin ( Δω t + Δ φ + {θ}_{HP} ) sin ( {ω}_{IF 1} t + {φ}_{1} ) )\end{matrix} ] . & ( 4.5 )\end{matrix}$$

Because V₁/V₀<<1, the third term in both Equations 4.4 and 4.5 is negligible.

When sgn(Δω)>0, addition of Equations 4.4 and 4.5 leads to cancellation of the second term in each expression and reinforcement between the first terms. When sgn(Δω)<0, subtraction of Equation 4.5 from Equation 4.4 produces the same effect. Thus,

vₘᵤₗₜ₁(t)+sgn(Δω)vₘᵤₗ₂(t)≈G_{HP}C_{det}GₘᵢₓG_{LNA}V₁ cos(ω_{IF1}t+φ₁+θ_{HP}). (4.6)

The context in which the present technology may be applied provides knowledge of Δω in one way or another. If the receiver is not managing the frequency of the intended signal, then software, or equivalently hardware, must sense the frequencies of the two signals. If the receiver is part of a system that manages the frequency ω₁ of the intended signal vis-à-vis the interfering signal, the sign of do is dictated in the process. In either case, the sum or difference output of the final hybrid 146 in FIG. 1 is selected in order to give the correct result as stated in Equation 4.6.

For generalized amplitude, phase, and frequency shift keying modulation, of which Quadrature Amplitude Modulation (QAM) is a subset, the interfering and desired signal become:

$$\begin{matrix}{v}_{in} ( t ) = {\sum }_{m = - ∞}^{∞} {V}_{0 m} cos ( {ω}_{0 m} t + {φ}_{0 m} ) {p}_{{T}_{0}} ( t - 2 {mT}_{0} ) + \\ {\sum }_{n = - ∞}^{∞} {V}_{1 n} cos ( {ω}_{1 n} t + {φ}_{1 n} ) {p}_{{T}_{1}} ( t - 2 {nT}_{1} - Δ t ) ,\end{matrix} \qquad ( 4.7 )$$

again with the assumption that V₀ₘ≧≧V₁ₙ, for all m and n. The pulse function p_{T}(t) is 1 for |t|<T, and zero elsewhere. The Vᵢₘ, ωᵢₘ, φᵢₘ terms are sets of values dictated by the modulation scheme and the bit stream that created the modulation. Note that the pulse sequences and hence the modulation schemes are independent for the intended and interfering waveforms. When the foregoing development is applied to Equation 4.7, one obtain Q.

$${V}_{out} = {C}_{det} {G}_{LNA} {G}_{mix} [ \begin{matrix}\begin{matrix}( \frac{Δ ω}{\sqrt{\begin{matrix}Δ {ω}^{2} + \\ {( RC )}^{- 2}\end{matrix}}} ) {\sum }_{n} {V}_{1 n} cos ( \begin{matrix}{ω}_{IF 1} t + \\ {φ}_{1}\end{matrix} ) \\ {p}_{{T}_{1}} ( \begin{matrix}t - 2 {nT}_{1} - \\ Δ t\end{matrix} ) +\end{matrix} \\ {\sum }_{m} {\sum }_{n} ( \begin{matrix}{V}_{1 n} \frac{{K ( RC )}^{- 1}}{\sqrt{\begin{matrix}Δ {ω}^{2} + \\ {( RC )}^{- 2}\end{matrix}}} u ( t - ( 2 m + 1 ) T ) \\ {e}^{- t / RC} cos \\ ( \begin{matrix}{ω}_{IF 0 m} t + \\ {φ}_{0 m}\end{matrix} ) {p}_{{T}_{0}} ( \begin{matrix}t - \\ 2 {mT}_{0}\end{matrix} )\end{matrix} ) + \\ {e}^{- t / RC} {\sum }_{m = - ∞}^{∞} ( \begin{matrix}{V}_{0 , m} cos ( \begin{matrix}{ω}_{IF 0 m} t - \\ {φ}_{0 m}\end{matrix} ) {\sum }_{k = - ∞}^{m} log \\ {( \frac{{V}_{0 , k}}{{V}_{0 , k - 1}} )}^{2} {e}^{2 {kT}_{0} / RC} {p}_{{T}_{0}} ( τ - 2 {mT}_{0} )\end{matrix} )\end{matrix} ] . \qquad ( 4.8 )$$

To obtain this result, the same procedure described by Equation 4.6 applies to Equation 4.8, with the sign of do determining whether output OUT 1 or OUT 2 is selected. For the interferer frequency and phase modulation cases, where V₀ₘ=V₀, the third term in Equation 4.8 vanishes. For an amplitude-modulated interferer of sufficiently high data rate, the third term has been shown to dominate the output and therefore minimize the interference rejection. The present technology is, therefore, most suitable for a constant-amplitude signal as the interferer, although no modulation restriction is placed on the intended signal.

The second term in Equation 4.8 is a term that represents the intermodulation that is filtered out by the high pass filter in Branch 2. Because this intermodulation is filtered out, it is no longer able to be rejected in the multiplication process and therefore remains at the output. This leaves residual intermodulation that is quantified in the section that follows. The rejection of this intermodulation is dependent on the frequency separation of the two signals and the time constant of the RC filter that is employed as high pass filter 134.

In order to evaluate the present technology, the scheme illustrated in FIG. 1 was implemented using available signal generators. The outputs of two Agilent E4433B signal generators were summed to produce the summed-signal input Vᵢₙ(t) to the system. The radio frequency splitter 110 was implemented with a Wilkinson Power divider. In Branch 1 the down conversion and quadrature splitting was performed by a Maxim 2828 IQ down converter with its local oscillator set to 2.437 GHz. In Branch 2, the log detector 132 employed was the Analog Devices AD8318 Demodulating Log Detector with a frequency range of 1 MHz to 8 GHz, which is the same log detector analyzed in previously mentioned Simoneau et al. article.

The high pass filter 134 in Branch 2 was implemented by an RC circuit with a corner frequency of 1 kHz. Another RC network performs the 90 degree splitting at the output of Branch 2. The design employed in this setup was highly frequency dependent and therefore required tuning to reject the intermodulation product that is 2Δω away in frequency. This would not represent a problem in implementation if IF filtering is employed at the output of the in-phase multiplier to eliminate adjacent band interference that resides at a predicable difference frequency. If this is done, the output of the system would simply be taken from the output of this IF filter, and no information about the interfering signal would need to be known.

The multiplication of the signals was carried out by the Analog Devices MLT04 multiplier which has a frequency range of zero to eight MHz. An inductor was also added to the output of Branch 2 in order to minimize external DC bias, which would cause significant corruption in the output. The outputs of the multipliers 142, 144 are then summed employing the Analog Devices AD835 chip that also is able to account for voltage imbalance in the 90 degree hybrids 128, 136. The output is then taken from the AD835 into an HP 8565E Spectrum Analyzer. Those of ordinary skill in the art will appreciate that all of the IF hybrids and the multipliers could be implemented digitally. However, the phase shift in the 90° hybrid is costly to implement digitally because more than one frequency is involved.

Signal modulation was implemented digitally in a Virtex 2 FPGA inside a Lyrtech SignalMaster baseband processing device. The data conversion rate employed for the experiment was 32 MHz with 14 bits in D/A conversion. The symbol rate for all modulated signals is 100 kHz. Three types of modulation were employed: quadrature phase shift keying (QPSK), 64-ary quadrature amplitude modulation (64-QAM), and binary frequency shift keying (BFSK). The 64-QAM modulation employs a square, equally spaced 8×8 constellation in the I-Q plane, and the BFSK employs a separation of 100 kHz between carriers. The modulated signals are generated at 1 MHz and then upconverted to 2.438 GHz through the use of a Maxim 2828 upconverter.

Theoretical results were derived employing the equations given above. The results labeled as modeled employ these equations along with output leakage in the analog multipliers of −45 dB, which was observed in experimentation. For all the figures that follow, the desired signal resides at 2.438 GHz and the interfering signal is varied in order to give the proper difference frequency employing the single-sideband signal generation method described by Weaver in his article “A third method of generation and detection of single sideband signals,” Proc. IRE, vol. 44, December, 1956, pp. 1703-5.

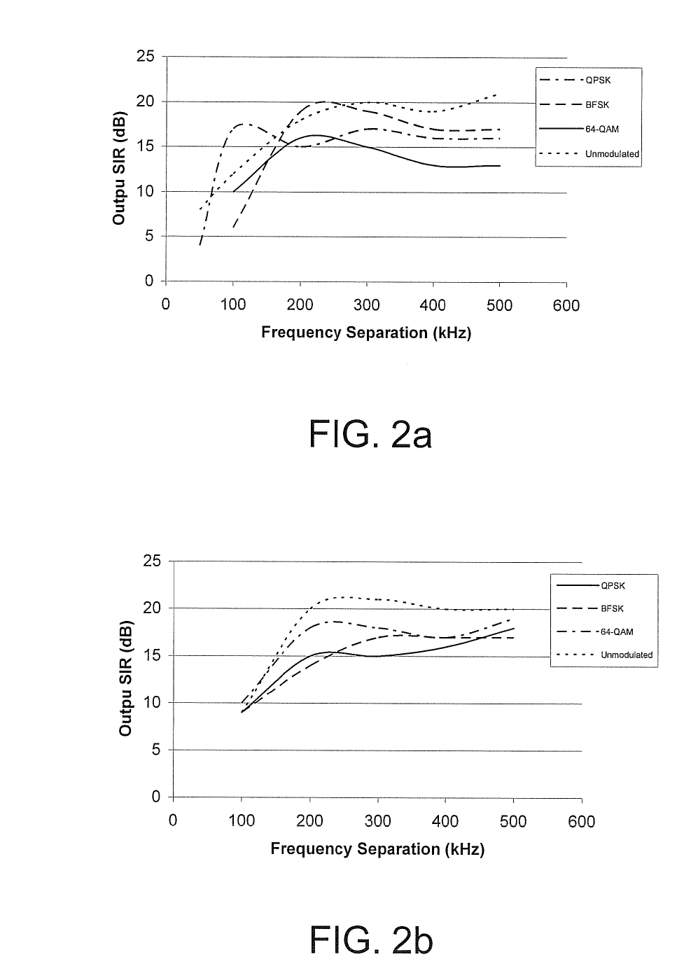

FIG. 2a shows the results of output signal to interference ratio (SIR) vs. frequency separation for a QPSK interferer and various types of modulation on the desired (small) signal. The input SIR for this case is −20 dB. The desired signal resides at 2.438 GHz, which translates to an IF of 1 MHz. 25 dB rejection of the intermodulation product at 2Δω is obtained if the 90 degree splitting circuit 136 in Branch 2 is properly tuned. The setup for FIG. 2b is identical to that for FIG. 2a except that the interferer modulation is BFSK.

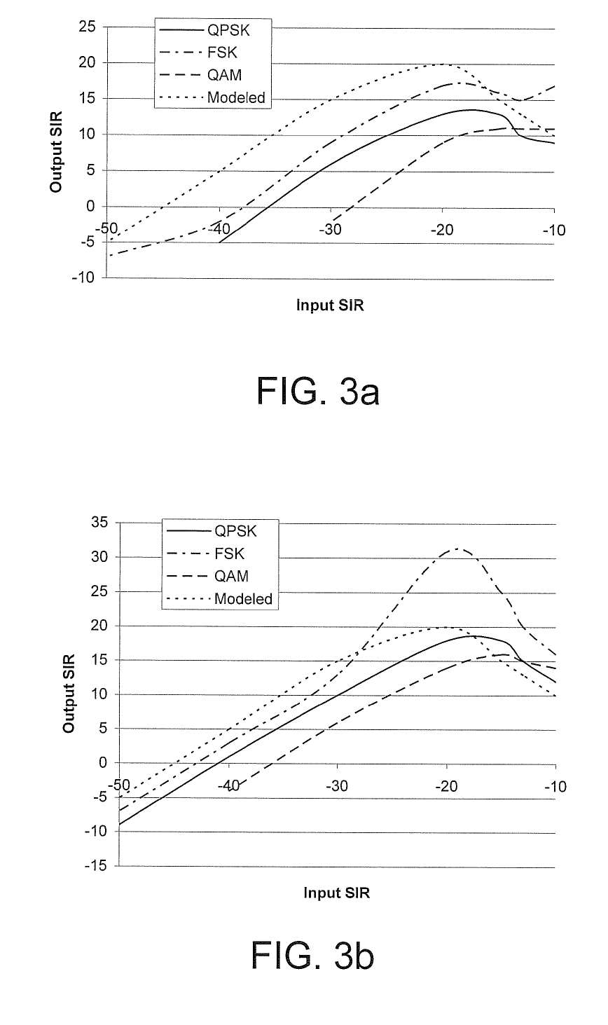

FIG. 3a shows the results of output SIR versus input SIR for a QPSK interferer. This plot shows that the theoretical limit of the ratio of V₁ to V₀ dominates at low levels of input SIR, but at an input SIR of −20 dB, the leakage of the multipliers due to DC offset error takes over the device's behavior. This plot shows the advantage of this interference rejection scheme to other forms in that the amount of rejection grows with interferer amplitude until the leakage dominates the output. A similar result is shown in FIG. 3b for a BFSK modulated interferer.

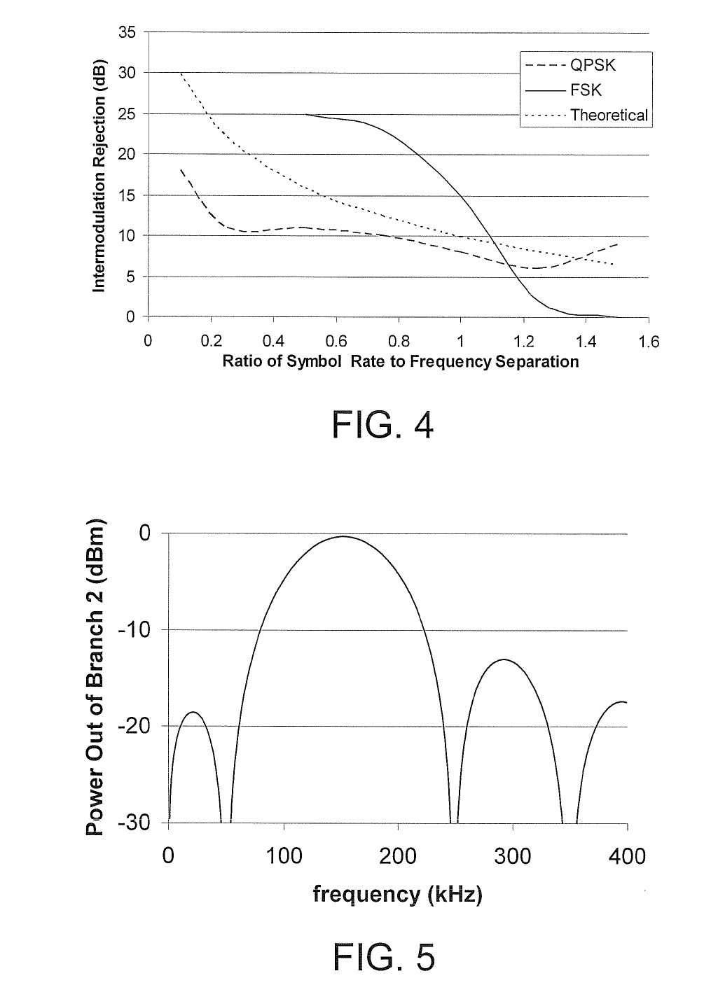

It was found experimentally that as the modulation rate of the interferer approaches and surpasses the frequency separation of the two signals, an intermodulation product arises in the main signal. The intermodulation rejection is defined as the ratio of side lobe power in the interfering input signal to the side lobe power in the desired output signal. A plot of the level of intermodulation rejection versus the ratio of symbol rate to frequency separation is given in FIG. 4. This plot shows that the intermodulation becomes significant as the ratio approaches and exceeds one. The desired signal is tuunodulated for this figure, and the modulation type for the interferer is varied. A sample spectral plot for the reason that this residual modulation occurs is shown in FIG. 5.

A significant observation stems from this plot. If we take the point at which the modulation rate is half of the frequency separation and QPSK is employed, there is a side lobe of the interfering signal that resides at the center frequency of the intended signal. FIG. 4 shows that the intended signal can still be recovered with an intermodulation rejection of greater than 10 dB, even when the side lobe of the interferer is greater than the main lobe of the intended signal at the intended signal's center frequency.

The interference canceling scheme shown in FIG. 1 has been analyzed analytically and experimentally. Experiments confirm its ability to reject a constant amplitude, high-power, near-in-frequency interferer in a manner that is proportional to the ratio of interferer to signal. Known limitations of this device are the input leakage in the multiplier for very high interference levels (greater than 25 dB), and intermodulation on the primary signal when the modulation rate of the interferer approaches the frequency separation between the two signals.

The presently disclosed technology finds particular application in dynamic frequency allocation, although other applications will be apparent to those of ordinary skill in the art in light of the present disclosure. A secondary user of the spectrum could communicate very close in frequency to a high-powered primary user such as an FM transmitter while maintaining a high quality of service and a low interference level for the FM band. Other applications include control of an interfering signal that emerges at a frequency near an ongoing communication. One of the strengths of the present technology is that the amount of interference rejection grows with a decrease in the input signal to interference ratio. It is therefore most suitable in cases where one man-made interference source is the primary obstacle to signal detection or communication in a narrow band of spectrum.

While the present subject matter has been described in detail with respect to specific embodiments thereof, it will be appreciated that those skilled in the art, upon attaining an understanding of the foregoing may readily produce alterations to, variations of and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for rejecting interference between a desired signal and an interfering signal, comprising:
dividing an input signal into first and second portions;
providing first and second signal processing branches, each branch providing different signal processing methodologies;
applying a first portion of the divided input signal to the first processing branch;
applying a second portion of the divider input signal to the second processing branch;
combining the outputs of the first and second processing branches to produce a sum signal and a difference signal; and
selecting for further processing as an intermediate frequency signal one of the sum signal or the difference signal based on the sign of the difference between the frequency of a desired signal and the frequency of an interfering signal.

2. The method of claim 1, wherein the first branch comprises a down converter and the second branch comprises a logarithmic detector.

3. The method of claim 2, further comprising:
passing the signal from the first branch through a low-pass filter prior to combining the outputs; and
passing the signal from the second branch though a high-pass filter prior to combining the outputs.

4. The method of claim 3, further comprising:
separating each of the output signals from the first and second branches into in-phase and quadrature components; and
multiplying the in-phase components from each branch together;
multiplying the quadrature components from each branch together; and
combining the multiplied in-phase and quadrature components to produce the sum signal and difference signals.

5. Apparatus for rejecting interference between a desired signal and an interfering signal, comprising:
a divider having an input terminal and a pair of output terminals,
a first multiplier having a first input terminal, a second input terminal, and an output terminal, the first input terminal coupled to one of the pair of output terminals from said divider;
a logarithmic detector having an input terminal and an output terminal, the input terminal coupled to another of the pair of output terminals from said divider; and
a hybrid device having first and second input terminals and first and second output terminals, the first output terminal configured to provide a signal corresponding to the sum of the signals applied to the first and second input terminals and the second output terminal configured to provide a signal corresponding to the difference between the signals applied to the first and second input terminals,
wherein the output terminal of the first multiplier is coupled to the first input of the hybrid device and the output terminal of the logarithmic detector is coupled to the second input of the hybrid device.

6. The apparatus of claim 5, further comprising:
a low-pass filter coupled between the output of the first multiplier and the first input of the hybrid device; and
a high-pass filter coupled between the output of the logarithmic detector and the second input of the hybrid device.

7. The apparatus of claim 6, further comprising:
an oscillator coupled to the second input of the first multiplier.

8. The apparatus of claim 7, further comprising:
a first 90° hybrid divider having an input, an in-phase output, and a quadrature output;
a second 90° hybrid divider having an input, an in-phase output, and a quadrature output;
a second multiplier having first and second inputs and an output; and
a third multiplier having first and second inputs and an output,
wherein the in-phase output of the first 90° hybrid divider is coupled to the first input of the second multiplier, the quadrature output of the first 90° hybrid divider is coupled to the second input of the third multiplier, the in-phase output of the second 90° hybrid divider is coupled to the second input of the second multiplier, and the quadrature output of the second 90° hybrid divider is coupled to the first input of the third multiplier.
